(19) United States
(12) Patent Application Publication
(10) Pub. No.: US 2008/0141804 A1
(43) Pub. Date: Jun. 19, 2008

(54) DEVICE FOR TRANSFORMING ROTARY MOTION INTO RECTILINEAR MOTION

(76) Inventors: Giuseppe Maffeis, Roncadelle (BRESCIA) (IT); Giuseppe Bellandi, Roncadelle (BRESCIA) (IT)

Correspondence Address: MCGLEW & TUTTLE, PC, P.O. BOX 9227, SCARBOROUGH STATION, SCARBOROUGH, NY, 10510-9227, US

(21) Appl. No.: 11/945,642

(22) Filed: Nov. 27, 2007

(30) Foreign Application Priority Data
Dec. 15, 2006 (IT) BS 2006 A 000220

(51) Int. Cl. F16H 29/00

(52) U.S. Cl. 74/116

(57) ABSTRACT

This invention concerns a device to transform rotary motion into rectilinear motion, which comprises a trapezoidal threaded (13) rotating screw (11) and a translating nut screw (12). Driving teeth (15) are assembled on board the nut screw (12), radially orientated towards the screw and each one with a truncated cone portion (17) which engages with a side of the threading of the screw. Each driving tooth (15) is supported in the nut screw by rotating on its axis and subjected to axial preload in order to remain constantly coupled to the threading of the screw.

### FIELD OF THE INVENTION

The present invention concerns an innovative device for transforming rotary motion into rectilinear motion for use with mechanical rectilinear operators or actuators.

### STATE OF THE TECHNIQUE

Ball screws are well known in the rectilinear operator or actuator field, where a turning screw is linked to a translating element, such as a nut screw, with the interposition of balls and where the translating element can be associated with a device to be actuated and subject to linear movements.

In a ball screw, however, problems relating to friction between the balls due to difference in speed in some points of contact and the use of lubrication to limit wear and reduce play so as to safeguard the functionality of the device, cannot be excluded.

### OBJECTIVE AND SUMMARY OF INVENTION

The objective of this invention is to provide a new, original, linking system between a nut and a turning screw or bolt, to form a mechanical rectilinear operator, without relying on balls and, however without the drawbacks complained about above, reliable and longer lasting and, above all, simple and economic to produce and to use.

The objective is reached with a device to transform rotary motion into rectilinear motion, which comprises basically a trapezoidal thread rotating screw and a translating nut screw, the latter equipped with pairs of driving teeth, radially orientated to the screw and each having a truncated cone portion that engages with one side of the threading of the screw, and where each tooth is supported in the nut screw and made to turn on its axis and is subject to axial preloading so as to have constant coupling with the threading of the screw.

The most outstanding advantages of this innovative embodiment lie in a substantial and permanent absence of sliding friction between driving teeth and threading of the screw nut, given that the axial preloading on each driving tooth interacting with the nut screw can be self-regulated so as to eliminate coupling play, in particular during each inversion of direction, and by the fact that the connection can be airtight or function in an oil bath, even if the absence of sliding friction already helps to limit wear of the components.

Furthermore, the device proposed here can be straightforwardly applied to any system, commanded by rectilinear motion with the use of normal support profiles (also available on the market) without the need of any mechanical machining and enables self-compensation of alignment errors and a simplified assembly method depending on the drive capacity required to command the device it is connected to.

### BRIEF DESCRIPTION OF THE DRAWINGS

Greater details of the invention will however become evident from the following description made in reference to the attached indicative and not limiting drawings, in which,

FIG. 1 is an exploded view of the components of the device proposed;

FIG. 2 is screw and screw nut assembled;

FIGS. 3 and 4 are two different external side views of the whole in FIG. 2;

FIG. 5 is a cross section of the device according to arrows A-A in FIG. 4; and

FIG. 6 is a way of using the system.

### DETAILED DESCRIPTION OF THE INVENTION

As shown, the device comprises a screw 11 supported and controlled to turn without translating and a nut screw 12 translating, without turning, along the screw 11. The body of the nut screw can be provided with any external configuration.

The screw 11 has trapezoidal thread 13 with given angled sloping sides. The body of the nut screw 12 has a bore 14 in which the screw 11 extends and couples with the threading of the latter by means of pairs of rotating driving teeth 15.

These driving teeth 15 are on board the nut screw 12, and in the example illustrated are they are arranged in pairs orientated radially, in opposite directions to the screw to balance the components applying force on the screw itself. Each driving tooth 15 has a cylindrical assembly portion 16, a truncated cone portion 17 facing towards, and engaging with the thread 13 of the screw and it is positioned to turn on its geometric axis.

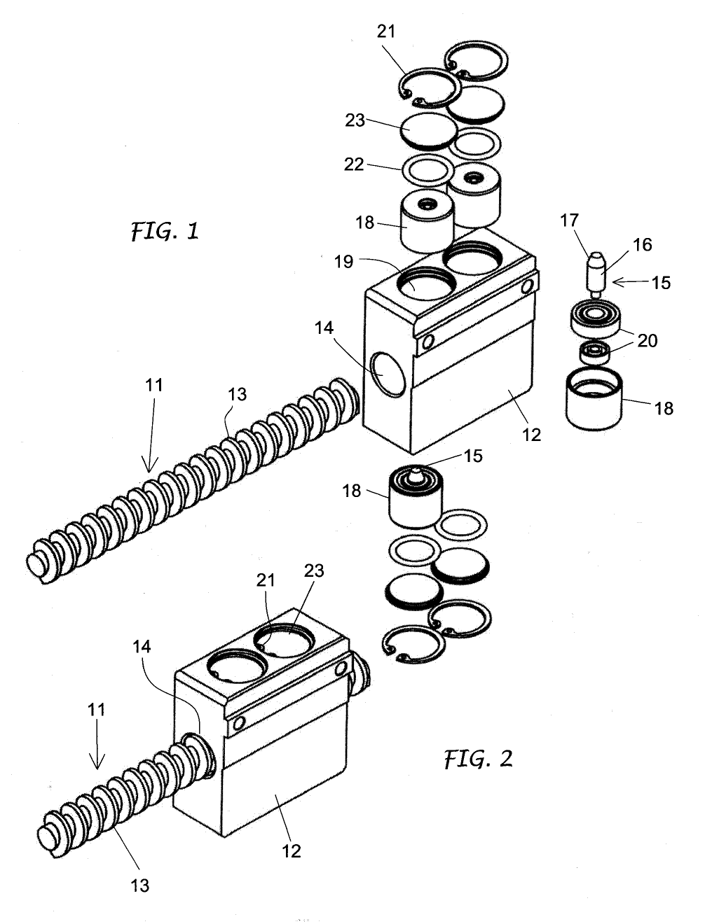

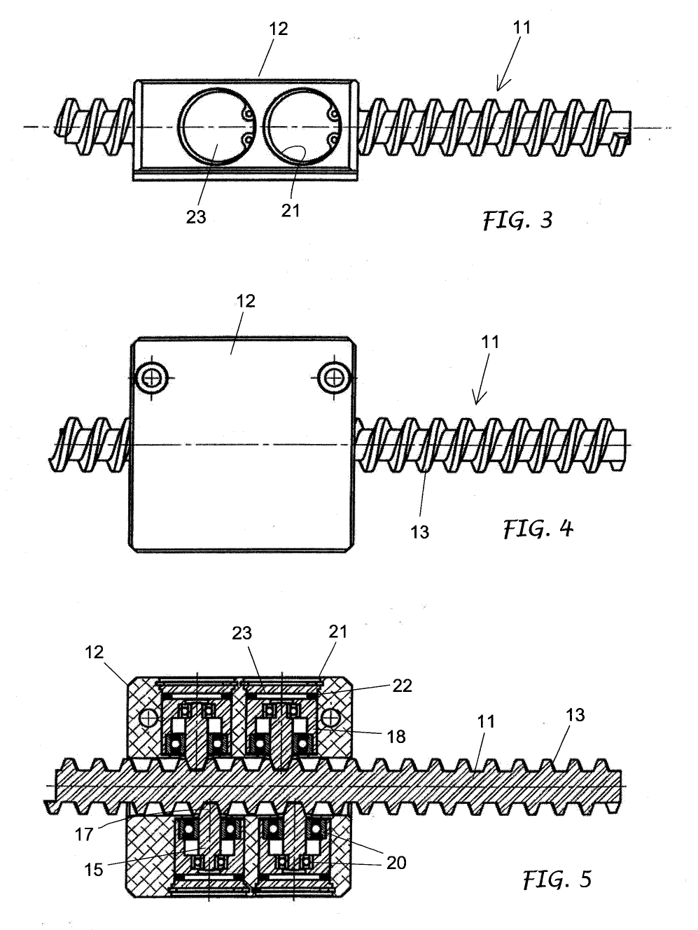

The driving teeth 15 can be assembled individually and turning directly in corresponding housings provided in the body of the nut screw 12. But in preference, and as shown in FIGS. 1 and 5, each of them is pre-assembled in a supporting capsule 18 that is then housed, like a cartridge, in a housing 19 provided in the body of the nut screw 12. To be more precise, the cylindrical portion 16 of the tooth 15 is supported in the capsule 18 by means of a bearing 20, and said capsule is pressure fitted, without being turning however, in the respective housing 19 so that the truncated cone portion 17 of the tooth couples with the threading 13 of the screw.

The capsule 18 is stopped and held axially in its respective housing 19 by means of a stop ring 21 and interposition of a flexible seal 22 and a closing disk 23 placed between said capsule and said ring.

This arrangement, and thanks to the seal 22, provides an airtight seal for each capsule with relative driving tooth and confers a coupling preload between the driving tooth 15 and the threading 13 of the screw 11 able to self ad just during functioning of the device. Furthermore, with the addition of protection elements—not shown—at the opposite ends of the bore 14 of the nut screw 12 the screw extends into, the coupling can be preset and function in an oil bath to have lifelong lubrication of the device. In addition, the screw can also be protected by a casing along all its length.

Basically the angle of the surface of the conical portion 17 of each driving tooth 15 corresponds to the surface of the sides of the threading 13 of the screw 11 and each time engagers with a side of said threading for the translation of the nut screw 12 in a direction, when the screw 11 turns in one direction, and with the opposite side of said threading for the translation of the nut screw 12 in the opposite direction when the screw is also turning in the opposite direction.

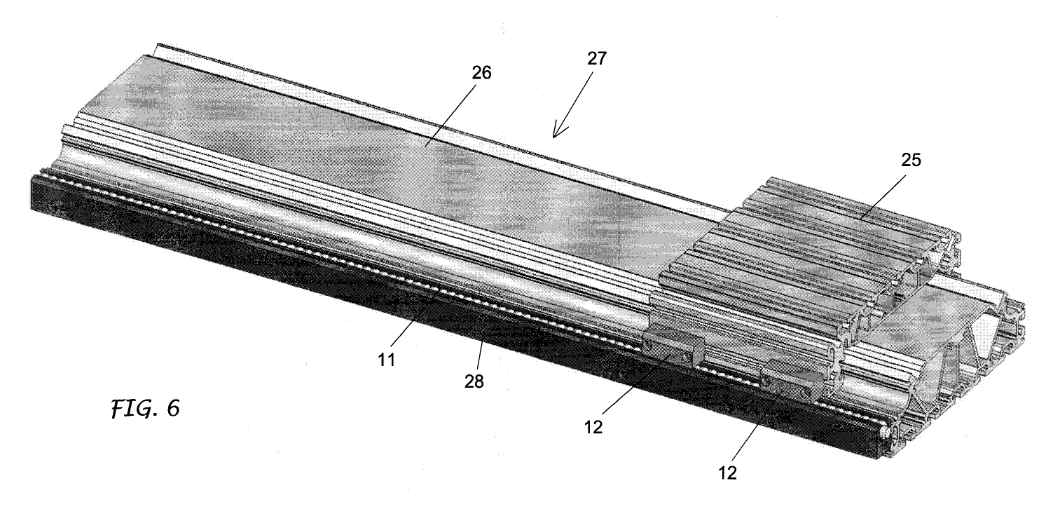

The device described above can be used, for example, to move a guided and sliding saddle 25 rectilinearly on a fixed part 26 of any tool 27. In this way, and as shown in FIG. 6, the screw 11 can be assembled to turn in a groove of a supporting profile 28 to be attached to the fixed part 26 of the tool, whereas the nut screw 12 connected to the screw 11 will be fixed to the saddle 25 to be moved and will be able to slide along the supporting profile.

Also worthy of note is that two or more nut screws can be coupled modularly to the screw depending on the power required to drive the tool in question.

1. A device to transform rotary motion into rectilinear motion, comprising a turning screw with trapezoidal threading and a translating nut screw with a through bore in which the screw extends, wherein pairs of driving teeth are mounted on board the nut screw, orientated radially towards the screw and each one with a truncated cone portion that engages with a side of the threading of the screw, and wherein each driving tooth is supported in the nut screw by rotating on its axis and subjected to axial preload in order to remain constantly coupled to the threading of the screw.

2. The device according to claim 1, wherein the threading of the screw has sloping sides at a set angle, and the truncated cone portion of each turning driving tooth has a surface with the same slant to interact each time with a side of the threading of the screw depending on the rotation direction of the screw and the translation direction of the nut screw.

3. The device according to claim 1, wherein each rotating driving tooth has a cylindrical portion to be assembled in the nut screw by means of bearings, the truncated cone portion being the continuation of said cylindrical part, facing towards the threading of the screw.

4. The device according to claim 3, wherein each rotating driving tooth is assembled to turn in a housing provided in the nut screw.

5. The device according to claim 3, wherein each rotating driving tooth is pre-assembled to rotate in a supporting capsule to be inserted and held axially without turning in a housing provided in the nut screw.

6. The device according to claim 5, wherein said supporting capsule is held hermetically in said housing, the capsule being constrained by a blocking ring with the interposition of a closing disk and a seal.

7. The device according to claim 1, wherein the bore of the nut screw the screw extends into, is blocked at its ends by protection elements and the screw is closed in or protected by a housing.

8. The device according to claim 1, wherein the rotating screw is supported by a fixed support and the translating nut screw, is fixed to a moving part of a tool to be powered.

9. The device according to claim 2, wherein each rotating driving tooth has a cylindrical portion to be assembled in the nut screw by means of bearings, the truncated cone portion being the continuation of said cylindrical part, facing towards the threading of the screw.
